(19) United States
(12) Patent Application Publication
(10) Pub. No.: US 2013/0175363 A1
(43) Pub. Date: Jul. 11, 2013

(54) Cartridge Sprayer System

(71) Applicant: Central Garden & Pet Company, Walnut Creek, CA (US)

(72) Inventors: Scott F. Dobias, Johns Creek, GA (US); Antonio Gatta, Philadelphia, PA (US); Christopher Murray, Philadelphia, PA (US); Christopher Phelan, Collingswood, NJ (US); David Schiff, Highland Park, NJ (US); Mathieu Zastawny, Philadelphia, PA (US)

(73) Assignee: CENTRAL GARDEN & PET COMPANY, Walnut Creek, CA (US)

(21) Appl. No.: 13/737,593

(22) Filed: Jan. 9, 2013

Related U.S. Application Data
(60) Provisional application No. 61/584,431, filed on Jan. 9, 2012.
(60) Provisional application No. 61/687,791, filed on May 1, 2012.

(51) Int. Cl. B05B 7/24; B65D 1/40; B05B 15/00

(52) U.S. Cl. CPC B05B 7/2464; B05B 15/00; B65D 1/40
USPC 239/308; 222/325; 220/676

(57) ABSTRACT

A sprayer system has a tank for containing water, a cartridge for containing a dispersible substance, and a sprayer for being in fluid communication with the tank and the cartridge. The sprayer includes a housing with a receptacle for removably receiving the cartridge. A pump is mounted to the housing and in fluid communication with a first passageway carried by the housing. The pump draws the water from the tank into the first passageway while the sprayer is in fluid communication with the tank. A second passageway is carried by the housing and in fluid communication with both the receptacle and the first passageway for supplying the dispersible substance from the cartridge to the first passageway and, thereby, forming the dispersion in response to operation of the pump while the receptacle is in receipt of the cartridge and the sprayer is in fluid communication with the tank.

### CROSS-REFERENCE TO RELATED APPLICATIONS

This application claims the benefit of each of U.S. Provisional Application No. 61/584,431, filed Jan. 9, 2012, and U.S. Provisional Application No. 61/687,791, filed May 1, 2012, all of which are incorporated herein by reference in their entirety.

### BACKGROUND

Many products are commercially available for use in pest control, weed control, fungus control, cleaning or the like. With many of such products, the active substance (e.g., the pesticide, herbicide, cleansing agent etc.) to be applied is pre-mixed with water (and/or other components) and provided to the user as a sprayable composition or treatment. The product may include a container for holding the sprayable treatment and a dispenser (e.g., sprayer) that allows the sprayable composition to be dispensed (e.g., sprayed) directly from the container. While these systems are convenient in that the composition is ready to be sprayed without the need for user measuring or mixing, the size and/or weight of these pre-mixed treatments may render them bulky and/or costly to distribute. Further, where the user needs more than one type of product or needs a large supply of products, the multitude of product containers may require a significant amount of storage space.

Some effort has been made to reduce the size and/or weight of these products by providing the active substance in a powder or liquid concentrate form. In many systems, the user is required to mix a specific quantity of the powder or liquid concentrate with a specific amount of liquid in a dispensing container (e.g., a sprayer). This can easily lead to user error, for example, since users may not wish to contaminate measuring devices with any particular treatment concentrate, and instead choose to estimate the quantities needed. Further, since the concentrate is mixed with the liquid inside the container, the container typically must be cleaned thoroughly before using another treatment. Any excess mixture may be disposed of, thereby resulting in wasted treatment. Additionally, some of such containers need to be pressurized (e.g., manually pumped) by the user to generate the spray, which can be cumbersome for large scale applications. Other systems require the use of a garden hose to supply water to be mixed with the active concentrate. While this may help to minimize the issues of proper mixing and contamination, such systems are limited, for example, to applications where a hose of adequate length is readily available.

Thus, there is a need for a sprayer system that addresses one or more of the issues mentioned above. In particular and for example, without any limiting to the scope of the present invention, there is a need for a sprayer system that minimizes the size and/or weight of the product, facilitates proper mixing with little or no waste, and avoids contamination of a liquid container, without being restricted to the use of a garden hose.

The foregoing discussion regarding background information is not extensive and is not intended to identify key or critical elements of the present inventions or to delineate the scope of the inventions.

### BRIEF DESCRIPTION OF THE DRAWINGS

In the following, reference is made to the accompanying drawings, which are not necessarily drawn to scale and may be schematic, and are all directed to an exemplary embodiment of this disclosure. The drawings are exemplary only, and should not be construed as limiting the inventions.

FIG. 1 is pictorial view of a cartridge sprayer system with its sprayer in a holstered configuration, wherein a discharge apparatus (e.g., wand) of the sprayer is in an unextended configuration, and an upper receptacle of the sprayer is capped.

FIG. 2 is a pictorial from the side opposite of FIG. 1, and FIG. 2 also shows capped bottles of the sprayer system in a stored configuration in side-loading holders of a tank of the system.

FIGS. 3 and 4 are pictorial views of the system without the capped bottles in their stored configuration, wherein one of the uncapped bottles is removably installed to the uncapped upper receptacle of the sprayer, the sprayer in an unholstered configuration, the discharge apparatus is in an extended configuration, and a fitting at an end of a flexible supply tube of the sprayer is removably installed in a receptacle of a closure assembly removably mounted to a mouth of the tank.

FIG. 5 is a perspective, cross-sectioned, partially exploded view of a portion of FIGS. 3 and 4, wherein FIG. 5 shows the mouth of the tank, the fitting, an end of the supply tube, the closure assembly with its lid opened, and a dip tube.

FIG. 6 is a partially cut-away, left elevation view of the sprayer with a left housing portion removed and one of the bottles installed to the upper receptacle of the sprayer.

FIG. 7 is an isolated, right elevation view of the left housing portion of the sprayer.

FIG. 8 is an isolated, pictorial, partially exploded view of the upper receptacle.

FIG. 9 is a mostly isolated, front pictorial view of a motorized pump assembly of the sprayer.

FIG. 10 is like FIG. 6, except for showing a trigger of the sprayer in an actuated configuration.

FIGS. 11-12 are top pictorial views primarily of the upper receptacle, wherein these views are generally from opposite sides of the upper receptacle.

FIG. 13 is a partially cut away, side cross-sectional view of a portion of the sprayer with one of the bottles installed to the upper receptacle of the sprayer.

FIG. 14 is a pictorial view of one of the capped bottles.

FIG. 15 is side elevation view of the bottle of FIG. 14 with its outer cap cross-sectioned.

FIG. 16 is a pictorial view of the bottle of FIG. 14 with its outer cap removed.

FIG. 17 is a side elevation view of the bottle of FIG. 16.

FIG. 18 is a schematic cross-sectional view taken along line 18-18 of FIG. 17.

FIG. 19 is an exploded view of the bottle of FIG. 16.

FIG. 20 is a perspective view of the tank.

FIG. 21 is an elevation view of the tank.

FIG. 22 is like FIG. 2, except for being an elevational view.

FIG. 23 is like FIG. 1, except for being an elevational view.

FIG. 24 is a side cross-sectional view of a portion of the sprayer with a cap installed to the upper receptacle of the sprayer.

### DETAILED DESCRIPTION

An Exemplary embodiment is described below and illustrated in the accompanying drawings, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention.

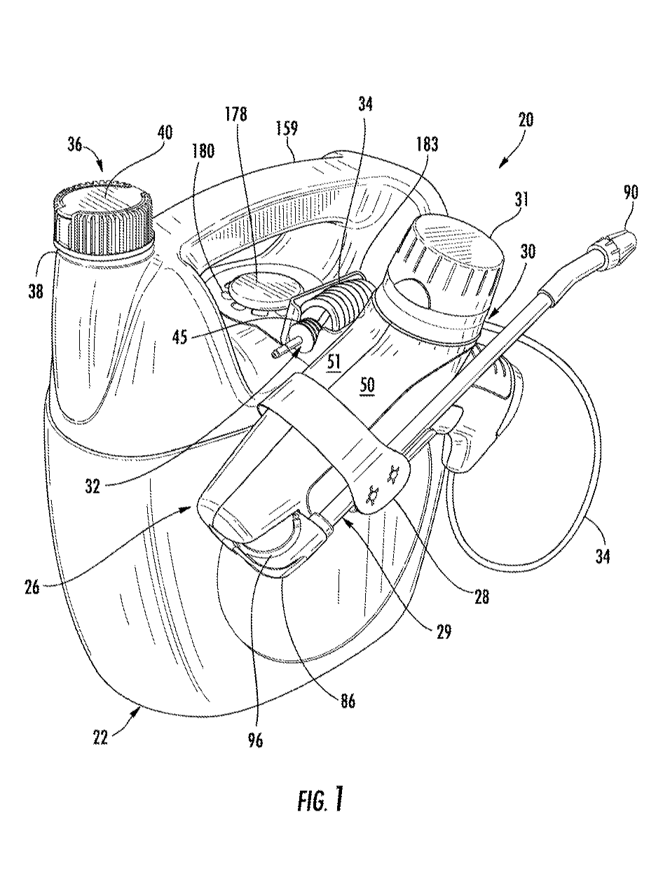

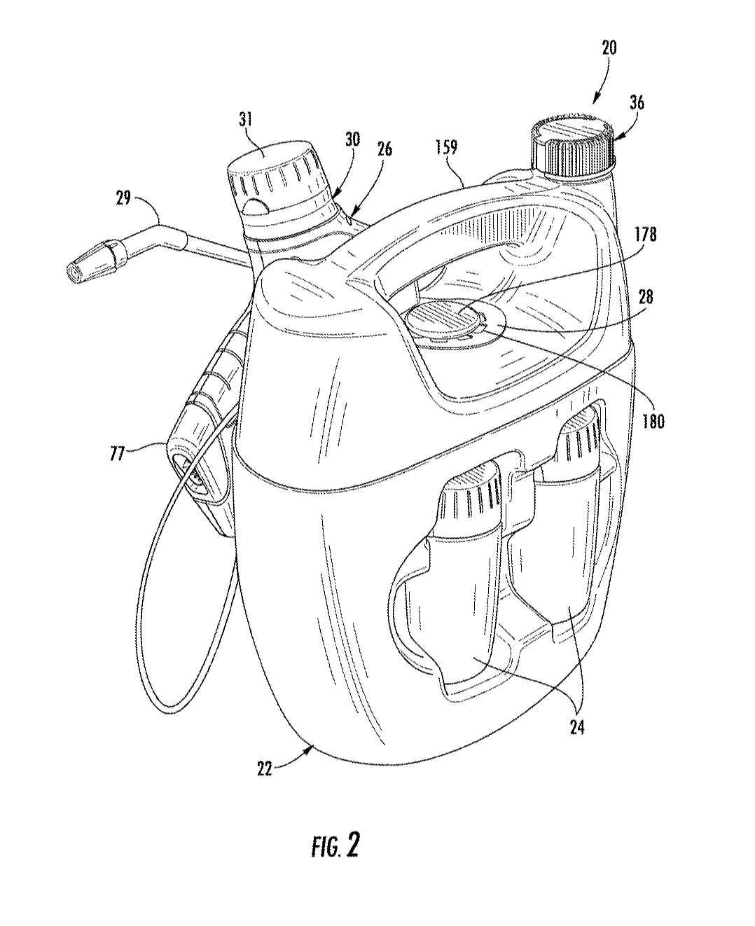

FIGS. 1 and 2 illustrate a cartridge sprayer system 20 in accordance with an exemplary embodiment of this disclosure. The system 20 generally includes a container or reservoir, that may be referred to as a tank 22, for containing a liquid dispersion medium, namely a solvent such as water; one or more cartridges that each may be in the form of a bottle 24 or other suitable container for containing a treatment concentrate; a sprayer 26 for mixing the liquid and concentrate with one another and dispensing (e.g., spraying) the resulting mixture or treatment (e.g., dispersion) by way of a discharge apparatus 29; and an optional holster 28 for use in storing the sprayer in a holstered configuration. FIGS. 1 and 2 show the sprayer 26 in a holstered configuration, wherein the discharge apparatus 29 is in an unextended configuration, and an opening of a upper receptacle 30 of the sprayer is closed by a cap 31. FIG. 2 shows the capped bottles 24 in a stored configuration.

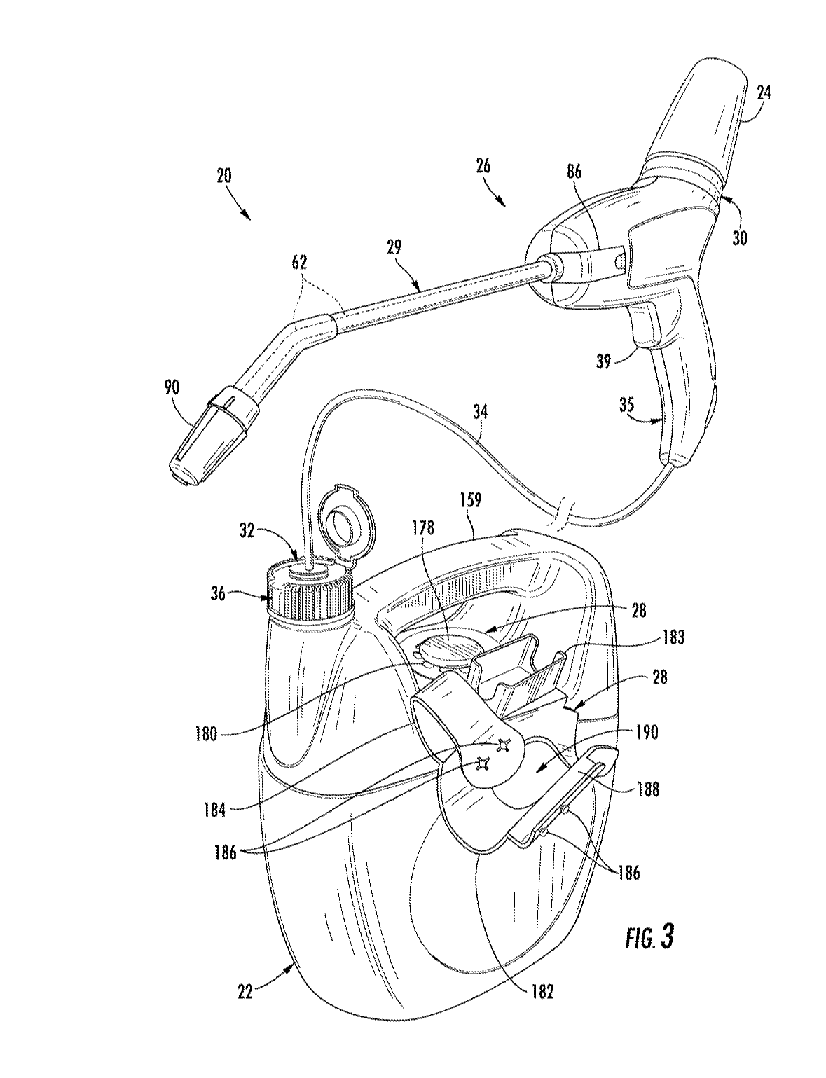

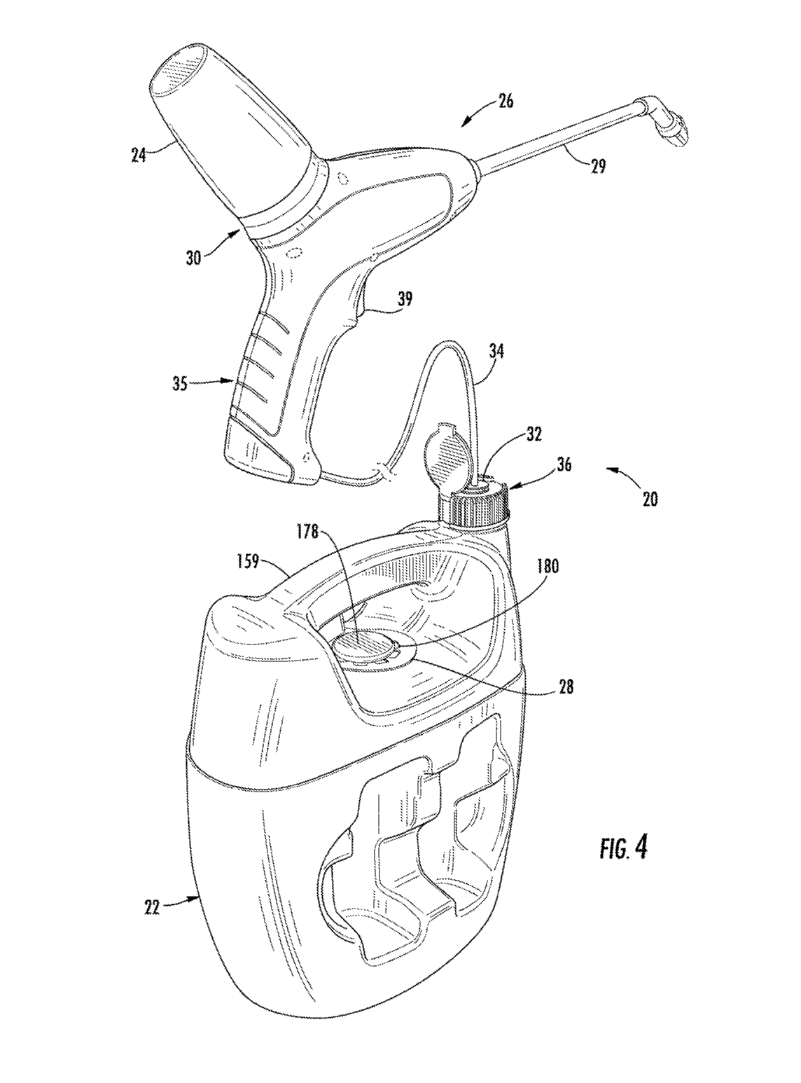

FIGS. 3 and 4 are like FIGS. 1 and 2, except that the bottles 24 are removed from the tank 22; one of the uncapped bottles 24 is removably installed in the upper receptacle 30; the sprayer 26 is in an unholstered configuration, wherein the discharge apparatus 29 is in an extended configuration; and a fitting 32 (e.g., quick-connect fitting) at an end of a flexible supply tube 34 of the sprayer is removably installed in a receptacle of a closure assembly 36 removably mounted to a mouth 38 of the tank 22. An exterior, lower portion of a housing of the sprayer 26 forms a grip 35 for being manually grasped with a user's hand, and a trigger 39 is pivotably mounted within the housing and protrudes outwardly through an elongate slot in the upper portion of the grip 35. While the system 20 is in the configuration shown in FIGS. 3-4 and the tank 22 contains the liquid and the cartridge/bottle 24 containing the concentrate is mounted to the upper receptacle 30, the sprayer 26 mixes the liquid and treatment concentrate with one another and dispenses the resulting mixture or treatment in response to the trigger 39 being squeezed, as will be discussed in greater detail below. The tank 22 may be provided with one or more straps, wheels, or any other suitable features for aiding in the usage of the system 20.

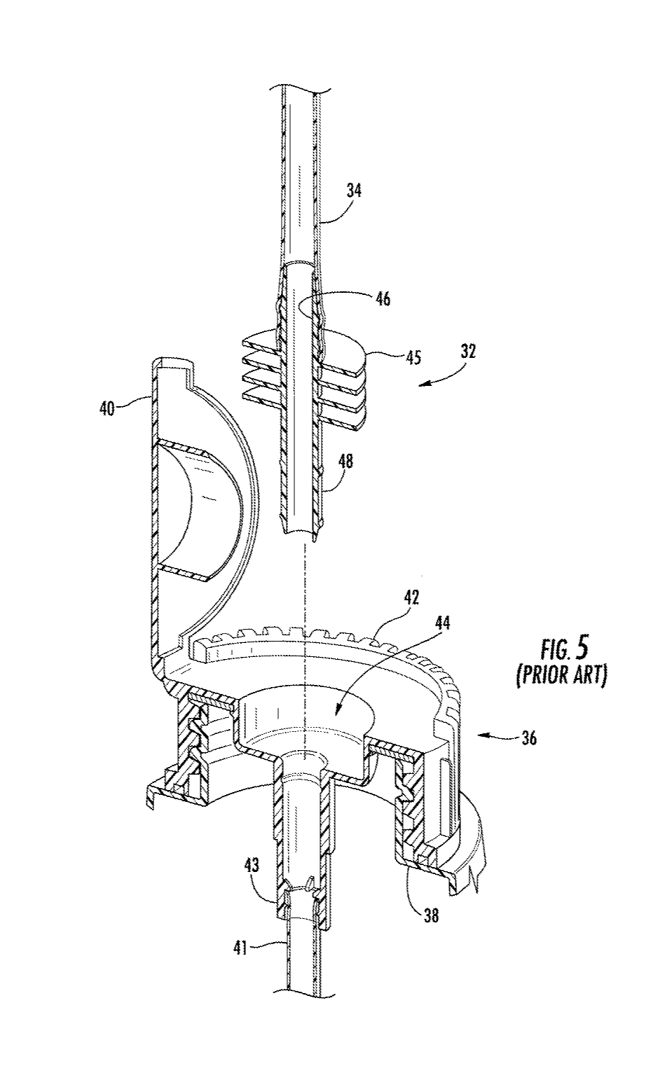

FIG. 5 is a perspective, cross-sectioned, partially exploded view of the mouth 38 of the tank 22, the fitting 32, an end of the supply tube 34, the closure assembly 36 with its lid 40 opened, and a dip tube 41, in accordance with the exemplary embodiment of this disclosure. That which is shown in FIG. 5 is conventional and not novel per se. In the following, features of FIG. 5 are described in the context of the exemplary embodiment. The mouth 38 of the tank 22 extends around and defines the tank's sole opening to the interior of the tank. A user of the system 20 typically supplies the liquid (e.g., water) to the interior of the tank 22 through the tank's opening while the closure assembly 36 is removed from the mouth 38, and thereafter the closure assembly 36 is removably mounted to the mouth for closing the tank's opening. The mouth 38 has one or more external, helical threads, and a cap 42 of the closure assembly 36 includes one or more internal, helical threads for removably mating with the external thread(s) of the mouth for allowing the closure assembly to be screwed onto, and screwed off of, the mouth. In addition or alternatively, other suitable fastening mechanisms may be used for securing (e.g., releasably securing) the closure assembly 36 to the mouth 38.

A passageway extends through the cap 42. The upper end of the passageway through the cap 42 is in the form of the receptacle 44 for removably receiving the fitting 32. The cap's receptacle 44 is in the form of a two-tier female opening in which a cylindrical upper portion of the cap's receptacle 44 has a larger diameter than a cylindrical lower portion of the receptacle 44. The upper and lower portions of the cap's receptacle 44 are adjacent and open to one another, and they are concentric with one another. A vent hole, for venting the interior of the tank 22 with ambient air, extends through a shoulder between the upper and lower portions of the receptacle 44, although the venting may be provided in any other suitable manner. The upper portion of the cap's receptacle 44 may be closed by the lid 40 that is typically hingedly connected to the cap 42. When the lid 40 is closed, there is a releasable interference (e.g., friction) fit between a downwardly protruding, annular male part of the lid and the upper portion of the receptacle 44.

An upper end of the dip tube 41 fits into a lower tube 43 of the cap 42. The dip tube 41 may be fixedly secured in the cap's lower tube 43 by an interference (e.g., friction) fit and/or any other suitable connection between the dip tube 41 and the cap's lower tube 43. The dip tube 41 extends downwardly to proximate the bottom of the interior of the tank 22, so that the lower end of the dip tube 41 is submersed in the liquid in the tank while the cap 42 is fastened to the mouth 38 of the tank. The lower, inlet end of the dip tube 41 is typically within the deepest portion of the interior of the tank 22 for use in drawing the liquid from the bottom of the interior of the tank.

A passageway extends through the fitting 32. The fitting 32 has a generally cylindrical, central body 45 configured for being gripped; an upper tube 46 extending coaxially upwardly from the central body, and a lower tube 48 extending coaxially downwardly from the central body. The fitting's upper and lower tubes 46, 48 are in fluid communication with one another by way of the passageway that extends through the fitting 32. The central body 45 and/or one or more of the tubes 46, 48 of the fitting 32 may be configured differently than shown in the drawings herewith.

The respective the end of supply tube 34 may be fixedly secured onto the fitting's upper tube 46 by an interference (e.g., friction) fit and/or there may be any other suitable connection between the supply tube 34 and the fitting's upper tube 46. The fitting's lower tube 48 fits releasably into the lower portion of the cap's receptacle 44 so that there is a snug interference (e.g., friction) fit therebetween, and the supply tube 34 is in fluid communication, via the fitting 32, with the dip tube 41. The supply tube 34 is used to draw/suck out the liquid from the interior of the tank 22, as will be discussed in greater detail below. The fitting 32 may be removed from and replaced into the receptacle 44, and the lid 40 may be opened and closed.

The fitting 32 and closure assembly 36 are not novel per se, and may be available from Mead Westvaco Calmar in Grandview, Miss. Other examples of caps and fittings that may be used are disclosed by U.S. Pat. Nos. 6,050,459 and 6,554,319. Alternatively, the dip tube 41 may be omitted and the supply tube 34 may extend through a suitable configured passageway through the cap 42 or other suitable closure assembly of the tank 22, so that the lower end of the supply tube is submersed in the liquid in the tank 22 for use in drawing the liquid from the bottom of the tank 22. In this regard, examples of caps and supply tubes that may alternatively be used are disclosed by U.S. Pat. Nos. 5,553,750 and 6,508,410. Alternatively, the supply tube 34 may receive the liquid dispersion medium from the tank 22 or any other suitable source in any suitable manner.

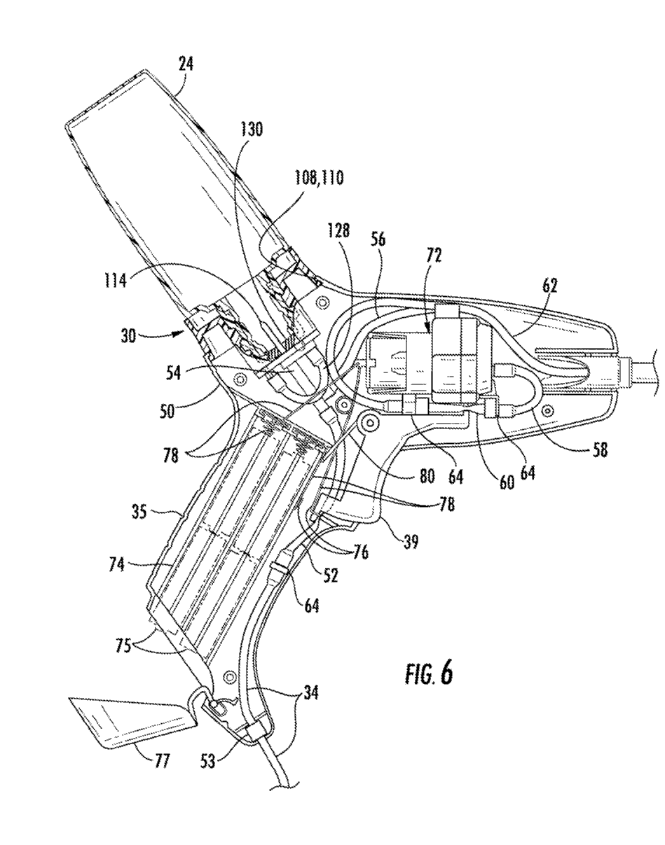

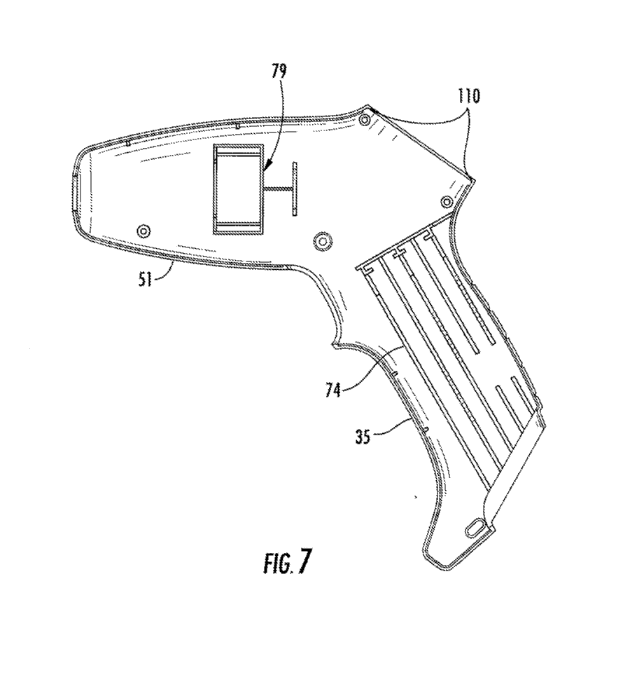

Referring to FIGS. 6 and 7, the housing of the sprayer 26 may be at least generally case-like, in that it may have right and left housing portions 50, 51 such as right and left halves or other suitably arranged portions. The upper receptacle 30 may optionally be characterized as being a portion of the housing of the sprayer 26. The housing portions 50, 51, like many other features of the system 20, may be made of polymeric (e.g., plastic) material, or any other suitable materials. The housing portions 50, 51 are fixedly connected to one another, and connected to the upper receptacle 30, through the use of any suitable fasteners (e.g., screws), connectors, adhesive material, mounting flanges, mounting grooves, and/or the like. More specifically, the housing portions 50, 51 may be connected together by screws (not shown) that respectively extend through internal standoffs of one of the housing portions and are screwed into internal standoffs of the other of the housing portions. These internal standoffs may be integral parts of the housing portions 50, 51 and may be respectively coaxially aligned with one another. Similarly, hinge pins, mounting assemblies, a battery compartment and other suitable features of the sprayer 26 may be integrally formed as parts of the housing portions 50, 51, or such features may be provided in any other suitable manner, as will be discussed in greater detail below.

In FIG. 6, the left housing portion 51 is removed from the remainder of the sprayer 26 to show interior features of the sprayer. The supply tube 34 may be mounted to and carried by the housing 50, 51 in any suitable manner, such as by way of a collar 53 that is fixedly mounted around the supply tube and contained in a compartment of the right housing portion 50. The housing 50, 51 of the sprayer 26 may contain and/or define numerous internal features. For example, a conduit that may be referred to as a first compound passageway extends through, and is carried by, the housing of the sprayer 26. The first compound passageway includes a downstream portion of the supply tube 34, a flexible upstream valve tube 52, a portion of a mixing fitting 54, an intake tube 56, a discharge tube 58, a flexible downstream valve tube 60, an upstream portion of a flexible discharge tube 62, and straight fittings 64 respectively connecting between the supply tube, upstream valve tube, discharge tubes and downstream valve tube.

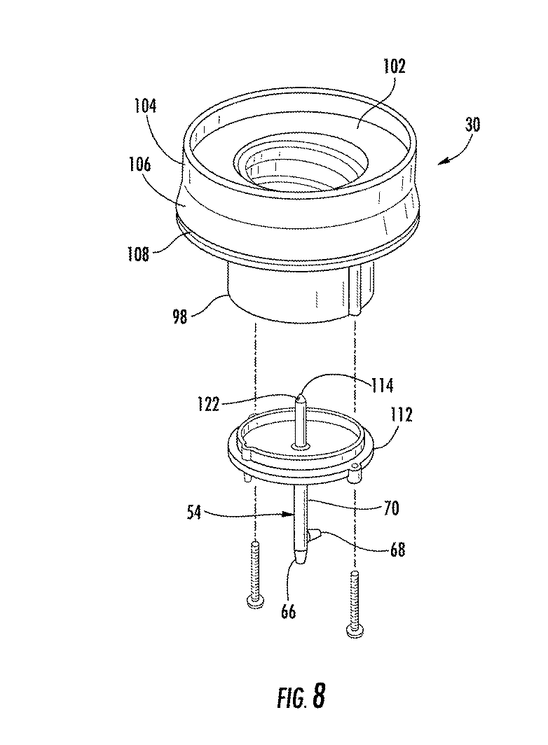

The mixing fitting 54 may be a tubular three-way tee fitting, or the like, that may be part of the upper receptacle 30. Referring to FIGS. 6 and 8, a first inlet tube 66 of the mixing fitting 54 is connected to the upstream valve tube 52. The outlet tube 68 of the mixing fitting 54 is connected to the intake tube 56. A second inlet tube 70 of the mixing fitting 54 is integral with a portion of the upper receptacle 30, as will be discussed in greater detail below. The first inlet and outlet tube 66, 68 of the mixing fitting 54 may be characterized as being portions of the first compound passageway that extends through, and is carried by, the housing of the sprayer 26. In contrast, the second inlet tube 70 of the mixing fitting 54 may be characterized as being part of a second compound passageway for supplying the treatment concentrate from a bottle 24 (e.g., cartridge) mounted to the upper receptacle 30 to the first compound passageway, as will he discussed in greater detail below.

Referring to FIG. 6, the housing of the sprayer 26 may comprise and/or contain other features such as, but not limited to an electric motorized pump assembly 72 positioned in the housing, a battery compartment 74 for containing disposable or rechargeable batteries 75 (e.g., lithium ion batteries) for providing electrical power to the motor of the motorized pump assembly, and an electrical circuit. The electrical circuit includes the batteries 75, the electric motor of the motorized pump assembly 72, contacts 76 of a manually operable (normally open) electrical switch for controlling the supply of electrical power to the motor, associated wiring 78, and a conductor (not shown) fixedly mounted to the interior of a cover 77. The cover 77 is for opening and closing an access opening to the battery compartment 74.

Referring to FIGS. 6 and 7, the lower parts of the sprayer's housing portions 50, 51, which internally define the battery compartment 74, externally define the hand-gripping portion 35 (e.g., pistol-grip-like portion) of the body of the sprayer 26. The grip 35 is proximate and/or adjacent the trigger 39. However, the various components of the system 20 may be configured in any other suitable manner.

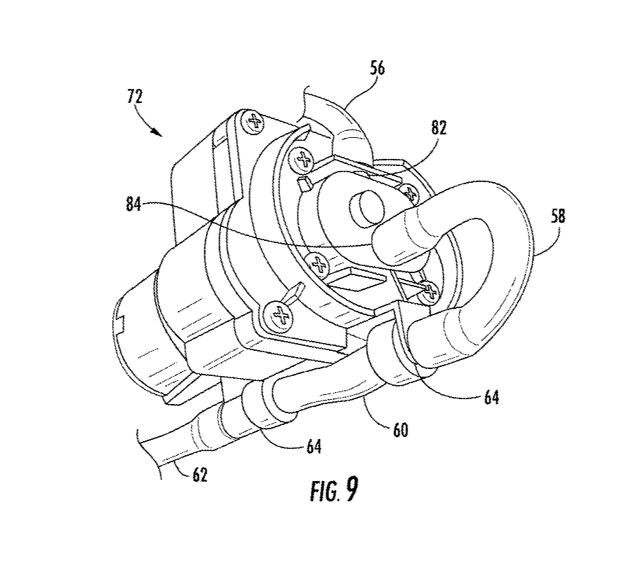

Referring to FIGS. 6 and 9, the motorized pump assembly 72 may be fixedly mounted within the housing of the sprayer 26 at least partially by way of opposite sides of a housing of the motorized pump assembly 72 being gripped between mounting assemblies (e.g. see mounting assembly 79 in FIG. 7) integrally formed as parts of the housing portions 50, 51, or in any other suitable manner. Referring to FIG. 9, the housing of the motorized pump assembly 72 includes two of the straight fittings 64, the pump is mounted to the front end of the housing of the assembly 72, and the motor is mounted to the rear end of the housing of the assembly 72. Gears (not shown) may be positioned in the housing of the assembly 72 as part of the drive train between output and input shafts (not shown) of the motor and pump, respectively.

The pump of the motorized pump assembly 72 is connected to, and thereby in fluid communication with, the first compound passageway, such as by being interposed in the first compound passageway as a result of the inlet 82 of the pump being connected to the downstream end of the intake tube 56, and the outlet 84 of the pump being connected to the upstream end of the discharge tube 58. Referring to FIGS. 6 and 8, the second compound passageway, or more specifically the second inlet 70 of the mixing fitting 54, is connected to the first compound passageway for supplying the treatment concentrate from a bottle 24 mounted to the upper receptacle 30 to the first compound passageway, as will be discussed in greater detail below.

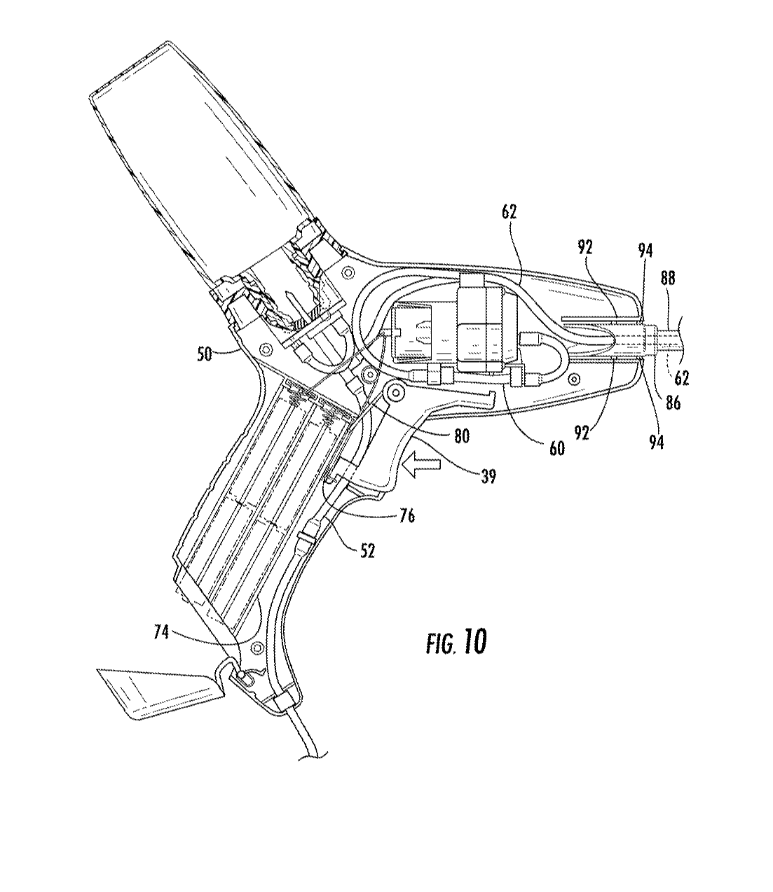

Referring to FIGS. 6 and 10, the opening and closing of the electrical contacts 76 is controlled by the movable trigger mechanism 39. The contacts 76 may be closed/the circuit may be completed by manually squeezing the trigger 39 no that it is in its actuated state shown in FIG. 9. The motorized pump assembly 72 operates while the contacts 76 are closed, and does not operate while the contacts are open. The trigger is outwardly biased by one or more springs, such as a coil spring 80 (e.g., a coil trigger spring). Only one leg of the coil spring 80 is shown in FIGS. 6 and 9, and it is engaged against a wall of the battery compartment 74. The coil of the coil spring 80 extends around the hinge pin to which the trigger 39 is pivotably mounted, and the other leg of the coil spring 80 engages against a surface of the trigger for biasing the trigger to the configuration shown in FIG. 6. Any other suitable switching/triggering mechanisms may be used. For example, differently configured trigger springs may be used, and the trigger 39 may be replaced with a button or any other suitable actuation feature, such as, but not limited to, any other suitable manually actuatable feature. Similarly, the motorized pump assembly 72 may be configured differently. For example and alternatively, the motorized pump assembly 72 and/or the batteries 75 may be carried by the tank 22, and electrical wire(s) between the trigger 39 and the motorized pump assembly and/or batteries 75 may extend along the supply tube 34.

In the exemplary embodiment, the pump and mixing fitting 54 are arranged so that the mixing fitting receives and at least partially mixes the liquid (from the tank 22) and the treatment concentrate (from the bottle 24) together at a position upstream from the pump, so that the pump draws the treatment from the outlet 68 of the mixing fitting, and the liquid and the concentrate become mixed and pressurized by the pump in the body of the sprayer 26. Alternatively, the pump and mixing fitting 54 may be configured differently, such as by the pump and mixing fitting being arranged differently with respect to the first compound passageway. For example, the connection between the outlet 68 of the mixing fitting 54 and the first compound passageway may, at least in theory, be positioned downstream from the pump in the first compound passageway, and the mixing fitting may be adapted so that the concentrate is drawn into the first compound passageway by way of a venturi effect, or the like.

Alternatively, one or more features of the motorized pump assembly 72 may be omitted or configured differently. For example, the pump may be any suitable type of pump that is actuated in any suitable manner. As a more specific example and in accordance with an alternative embodiment, the electric motor may be omitted and the pump may be a generally conventional spray-bottle pump that comprises spring-biased check valves and a spring-biased piston, wherein the piston is positioned between the check valves and is cooperatively associated with the trigger 39 so that the piston reciprocates in response the trigger being repeatedly manually squeezed and released.

In the exemplary embodiment, one or more valves may be positioned in the first and/second compound passageways, such as for restricting (e.g., preventing) any backflow of the concentrate or treatment into the tank 22, in a manner that seeks to prevent the liquid in the tank 22 from being contaminated with the concentrate/treatment. For example, and as shown in FIG. 6, the sprayer 26 includes pinch tube valves that are normally closed. More specifically regarding the pinch tube valves in their closed configurations, when the trigger 39 is in its outward configuration shown in FIG. 6, the upstream and downstream valve tubes 52, 60 are pinched closed between respective surfaces of the trigger 39 and stops integrally formed as parts of the right housing portion 50. Therefore, the trigger 39 may be referred to as an actuator for both of the pinch tube valves, wherein the pinch tube valves are positioned on opposite sides of the rotational axis of the trigger (e.g., the hinge pin to which the trigger is pivotably mounted). FIG. 10 shows the pinch tube valves in their open configurations, in which the trigger 39 is in its inner configuration and the upstream and downstream valve tubes 52, 60 are positioned in gaps between the respective surfaces of the trigger and the stops integrally formed as parts of the right housing portion 50, so that the pinch tube valves are open. More specifically, the trigger 39 has arms positioned on opposite sides of the hinge pin that pivotably carries the trigger, and the valves (e.g., valve tubes 52, 60) are respectively actuated by the arms. One or more of the pinch tube valves may be omitted and/or replaced with any other suitable valve(s) and associated actuator(s).

Referring to FIGS. 3 and 10, the discharge apparatus 29 includes a downstream portion of the discharge tube 62 extending through both a base 86 and a sheath 88 (e.g., a rigid tube). Portions of the discharge tube 62 that are hidden from view are schematically illustrated by dashed lines in FIGS. 3 and 10. The base 86 is pivotably mounted to the right housing portion 50 and/or the left housing portion 51, and the sheath 88 is fixedly connected to the base. A spray nozzle 90 of the discharge apparatus 29 is connected to both the downstream end of the discharge tube 62 and the free end of the sheath 88, for dispensing the mixed treatment from the discharge tube 62, The nozzle 90 may be omitted or replaced with one or more suitable nozzles, spouts, perforated plates, or the like. The discharge apparatus 29 may optionally be referred to as a wand, or the like, and the sprayer 26 may include any suitable discharge apparatus, wand, nozzle, or the like.

The sheath 88 more be more generally referred to as a support member, and the sheath may be replaced with any other suitable support member, such as a rigid rod to which the downstream portion of the discharge tube 62 is externally strapped or otherwise supported. Alternatively, the downstream portion of the flexible discharge tube 62 may be in the form of a rigid tube, such that the additional support member (e.g., sheath 88) may optionally be omitted.

Referring to FIGS. 1 and 10, the base 86 of the discharge apparatus 29 is positioned in a slot defined in the right housing portion 50. As best understood with reference to FIG. 10, the base 86 is pivotably mounted to the right housing portion 50 by way of one or more hinge pins 92. The hinge pins 92 may protrude inwardly from opposite upper and lower walls of the right housing portion 50 that define the slot that is in receipt of the base 86, so that the discharge apparatus 29 may be pivoted through substantially one hundred and eighty degrees between the extended and unextended configurations shown in FIGS. 2-4, respectively. The hinge pins 92 may protrude pivotably into respective holes in opposite upper and lower walls of the base 86. The opposite upper and lower walls of the right housing portion 50 may each include a protruding member 94. Referring also to FIG. 1, inner ends of the protruding members 94 are respectively received in curved guide channels 96 defined in the opposite upper and lower walls of the base 86. Each of the opposite ends of the guide channels 96 may comprise a detent. The detents are for releasably receiving the inner ends of the protruding members 94 for releasably holding the discharge apparatus 29 in its extended and unextended configurations. Alternatively, one or more of the hinge and other features associated with the discharge apparatus 29 being transitionable between the extended and unextended configurations may be configured differently or be omitted. For example, the base 86 may optionally be fixedly connected to and/or integrally formed with the right housing portion 50 and/or the left housing portion 51 such that the discharge apparatus 29 may not be transitionable between the extended and unextended configurations, such that the discharge apparatus 29 remains extended.

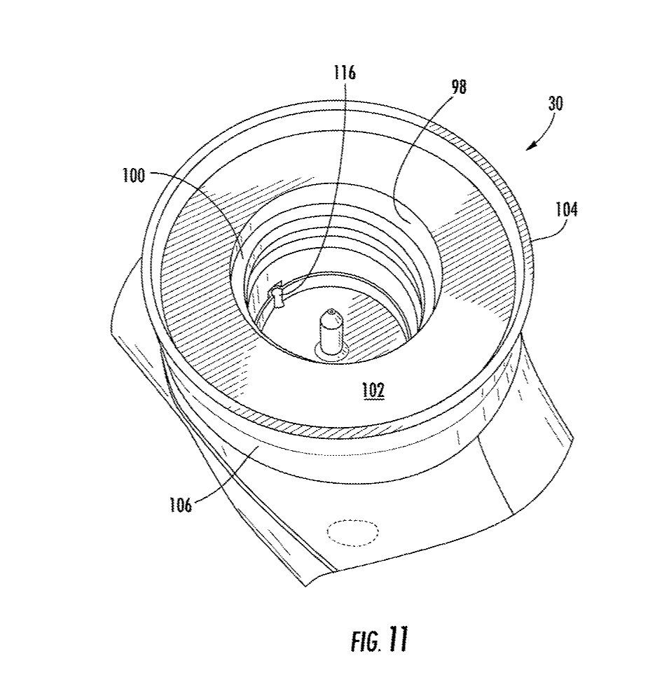

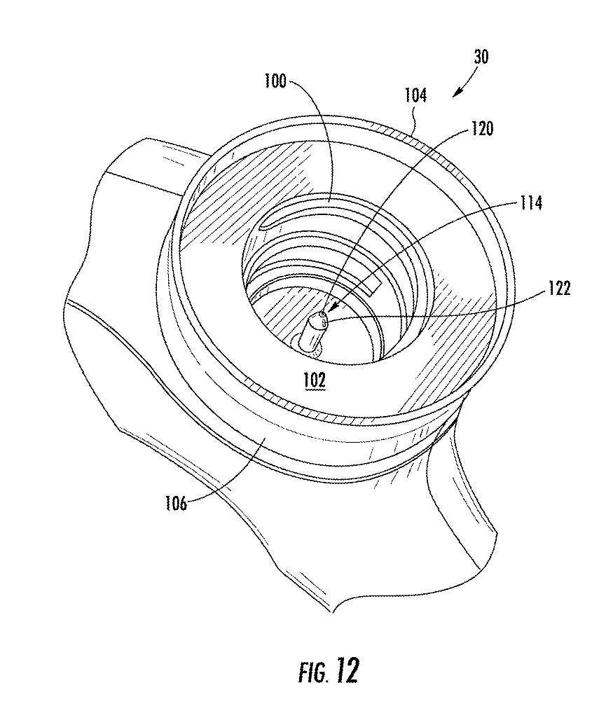

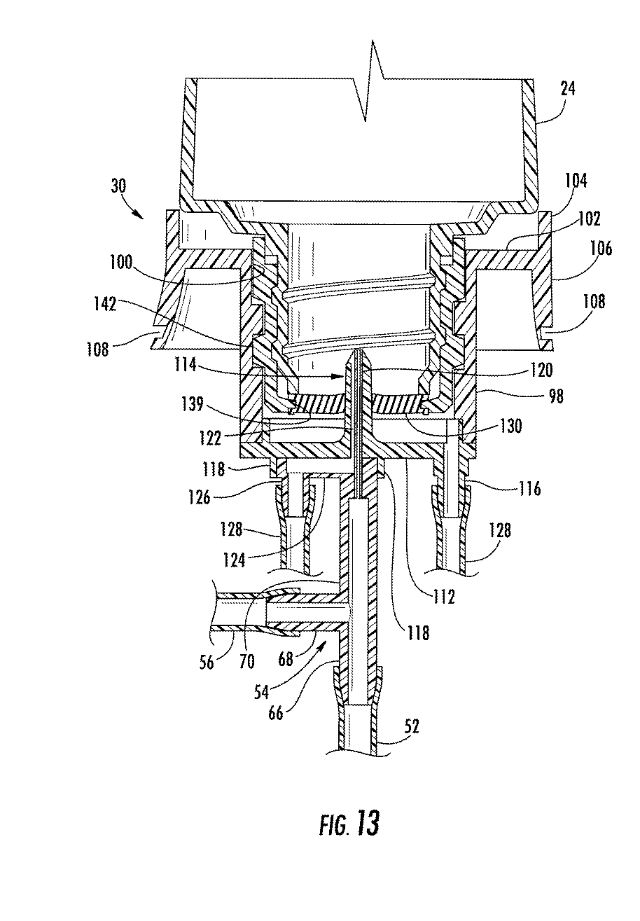

Reiterating from above with reference to FIG. 6, the housing of the sprayer 26 may be in the form of housing portions 50, 51 that are connected to the upper receptacle 30, and FIG. 8 is an isolated, exploded view of the upper receptacle 30. In addition, FIGS. 11 and 12 are top pictorial views primarily of the upper receptacle 30, and FIG. 13 is a side cross-sectional view showing the upper receptacle 30 mated with one of the bottles 24 (e.g., cartridges).

Referring to FIG. 13, the upper receptacle 30 includes a generally or substantially cylindrical sidewall 98 that extends around an interior space or the upper receptacle 30. Opposite ends of the sidewall 98 extend around opposite upper and lower openings to the interior space of the upper receptacle 30. The sidewall 98 includes at least one helical internal thread 100 that extends radially inwardly from, and is integral with, the interior surface of the sidewall. The internal thread 100 extends radially into the interior space of the upper receptacle 30 and substantially to the upper opening to the interior space of the upper receptacle 30.

With continued reference to FIG. 13, the upper receptacle 30 includes an annular radial flange 102 extending outwardly from the upper end of the sidewall 98, and annular upper and lower axial flanges 104, 106 extending from the outer periphery of the radial flange 102. The lower axial flange 106 is outwardly tapered in the downward direction and fits into an upper opening in the housing 50, 51 of the sprayer 26. The lower axial flange 106 includes an outer annular mounting groove 108 in receipt of an annular, radial mounting flange 110 (FIGS. 6 and 7) of the housing portions 50, 51, for mounting the upper receptacle 30 to the housing portions. The mounting flange 110 of the sprayer's housing 50, 51 extends around and defines the upper opening of the housing into which the receptacle's lower axial flange 106 extends. Alternatively or additionally, the upper receptacle 30 may be mounted to the housing portions 50, 51 in any other suitable manner, such as by interchanging the positions of the mourning groove and flange 108, 110.

Referring to FIGS. 8 and 13, the lower opening to the interior space of the upper receptacle 30 is closed or otherwise suitably obstructed by a base 112 that is mounted to the lower end of the sidewall 98 by screws or other suitable fasteners or fastening techniques. The base 112 may generally be in the form of, or comprise, a disk. A rod-shaped protruding member 114 (e.g., a generally or substantially blunt compound needle) extends upwardly from the base 112 and substantially coaxially into the interior space of the upper receptacle 30. In the exemplary embodiment, at least a portion of the protruding member 114 is fixedly mounted to, or fixedly integrally formed with, the base 112 of the upper receptacle 30. Referring to FIG. 13, an upstream vent tube 116 extends downwardly from the base 112, and the passageway through the upstream vent tube is open to the interior space of the upper receptacle 30. A lower receptacle 118 extends downwardly from the base 112, and an interior space of the lower receptacle is open to the interior space of the upper receptacle 30 through a portion of a hole that extends through the protruding member 114. An inner tube 120 extends through one side of the hole in the protruding member 114, so that a portion of the protruding member's hole is in the form of a venting passageway 122 having opposite ends that are respectively open to the interior space of the upper receptacle 30 and the interior space of the lower receptacle 118. The passageway through the inner tube 120 has opposite ends that are respectively open to the interior space of the upper receptacle 30 and the interior of the mixing fitting's second inlet 70.

Referring to FIGS. 8 and 11-13, the upper end of the protruding member 114 may be characterized as being in the form of a substantially blunt needle, or a substantially blunt compound needle that a user may touch with their finger substantially without any risk of being pricked or punctured thereby. For example, an upper, outer surface of the protruding member 114 may be in the form of a substantially frustoconical and/or rounded surface that tapers outwardly and downwardly from the upper end of the inner tube 120 to a cylindrical lower outer surface of the protruding member. In the exemplary embodiment and as best understood with reference to FIGS. 12 and 13, the upper opening of the venting passageway 122 is defined by the substantially frustoconical and/or rounded upper outer surface of the protruding member 114. The protruding member 114 may be characterized as a compound needle (e.g., a blunt compound needle) because, for example, it includes at least two passageways extending therethrough, and those passageways may be in the form of the venting passageway 122 and the passageway through the inner tube 120. Alternatively or in addition to the protruding member 114 having a substantially blunt end, other features may be present for protecting a user's finger tips from the end of the protruding member, such that the protruding member may have a sharp, or at least sharper, end. For example, the receptacle 30 and/or a bottle 24 may have one or more lock-out features (not shown) that restrict a user from touching the end of the protruding member 114, of the like.

Referring to FIG. 13, the protruding member 114, the upstream vent tube 116 and lower receptacle 118 may be integrally formed with, or at least partially integrally formed with, the base 112. The base 112 and the upper receptacle 30 may be made of polymeric (e.g., plastic) material, although the inner tube 120 may be constructed of metal, such as stainless steel. Irrespective, the inner tube 120 may characterized as being part of the protruding member 114, and these features, associated features and other features of the system 20 may be constructed differently and/or constructed of different materials. The protruding member 114 may have a maximum outer diameter of about an eight of an inch or less, or any other suitable diameter. The blunt end of the protruding member 114 may be formed by molding, machining, or in any other suitable manner.

With continued reference to FIG. 13, the upper end of the mixing fitting's second inlet 70 may be in the form of, or may be mounted to or integrally formed with, a closure fitting 124 that is mounted to and closes, or otherwise suitably obstructs, the lower opening of the lower receptacle 118. For example, there may be a friction fit and/or any other suitable connection (e.g., by way of adhesive material) between the closure fitting 124 and lower receptacle 118, or the closure fitting and lower receptacle may be parts that are integrally formed together or provided in any other suitable manner.

A downstream vent tube 126 extends downwardly from the closure fitting 124, and the passageway through the downstream vent tube is open to the interior space of the lower receptacle. A flexible intermediate vent tube 128 is connected between the lower ends of the upstream and downstream vent tubes 116, 126. Accordingly, a third compound passageway includes the upstream, downstream and intermediate vent tubes 116, 126, 128, the venting passageway 122 and the interior space of the lower receptacle 118. The third compound passageway extends through, and is carried by, the housing of the sprayer 26, for venting with ambient air the interior of a bottle 24 (e.g., cartridge) mounted to the upper receptacle 30, in the exemplary embodiment, the third compound passageway is substantially isolated from each of the first and second compound passageways.

Referring to FIGS. 6 and 13, each of the bottles 24 generally comprises a container that contains the treatment concentrate, and a septum 130 obstructing (e.g., closing) an opening to the interior of the bottle. The receptacle 30 includes the protruding member 114, or one or more suitable hollow needles (e.g., side by side needles or coaxially nested needles) used as or in place of the protruding member, for piercing or otherwise extending through the septum 130 of the 24 bottle installed to the receptacle 30, and supplying the liquid dispersion medium (e.g., the treatment concentrate) from within the bottle 24 to the mixing fitting's inlet 70 by way of the passageway through the inner tube 120. The passageway through the inner tube 120 may be sized for throttling or otherwise controlling the amount of concentrate that flows through the inner tube 120 to the inlet 70 of the mixing fitting 54 in response to operation of the motorized pump assembly 72. More generally, one or more features may be positioned in the flow paths, such as in the flow path between the upper receptacle 30 and the respective inlet 70 of the mixing fitting 54 and/or in the flow path between the upstream end of the supply tube 34 and the respective inlet 66 of the mixing fitting, for throttling flow, controlling flow, restricting backflow, or the like. For example, one or more throttling features (e.g., a valve and/or orifice) may be positioned in the flow paths. The throttling feature(s) may be configured so that a particular/predetermined amount of the treatment concentrate is drawn into the mixing fitting 54 in response to operation of the pump. Alternatively, the throttling feature(s) may allow the user to adjust the amount of treatment concentrate that is metered into the mixing fitting 54 to be mixed with the liquid dispersion medium (e.g., water) from the tank 22.

The septum 130 is typically configured for maintaining the opening to the interior of the bottle 24 in a closed configuration except when the protruding member 114, or the like, extends through the septum (e.g., the septum is self-sealing and closes the opening to the interior of the bottle 24 when the needle(s) are withdrawn from the septum). The flat septum 130 may be about a sixteenth of an inch thick, and it may cut from flat, twenty durometer silicon stock. Alternatively, any other suitably configured septum, or the like, may be used

Optionally, the protruding member 114 may comprise, or be replaced with, one or more hollow needles for piercing the septum of the bottle 24, for supplying the treatment concentrate from within the bottle to the inlet 70 of the mixing fitting 54. In this regard, these needles of the upper receptacle 30 may be stainless steel needles for providing two separate fluid passageways, one for the treatment concentrate from within the bottle 24, and the other for ambient air, for venting the bottle 24. The needles may be attached to a polymeric base or support (e.g., base 112) having features for facilitating mounting of the needle assembly, wherein the polymeric support seals against the exterior of the needle(s) and defines passageways for being respectively in fluid communication with passageways through the needles. The polymeric support (e.g., base 112), like many other components of the system 20, may be constructed from one or more of polypropylene, nylon or ABS plastic, and/or any other suitable material. Each needle, or the flow path(s) associated with the needle(s) (e.g., the venting passageway 122 and/or the passageway through the inner tube 120) may be sized, or may optionally be equipped with one or more offices, valves or check valves, or other suitable features, for controlling the flow therethrough.

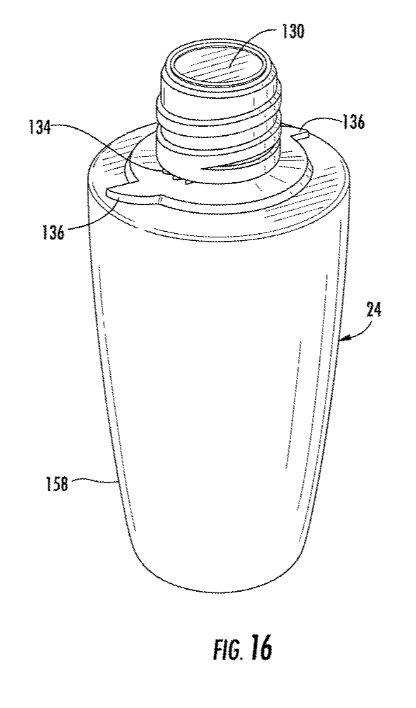

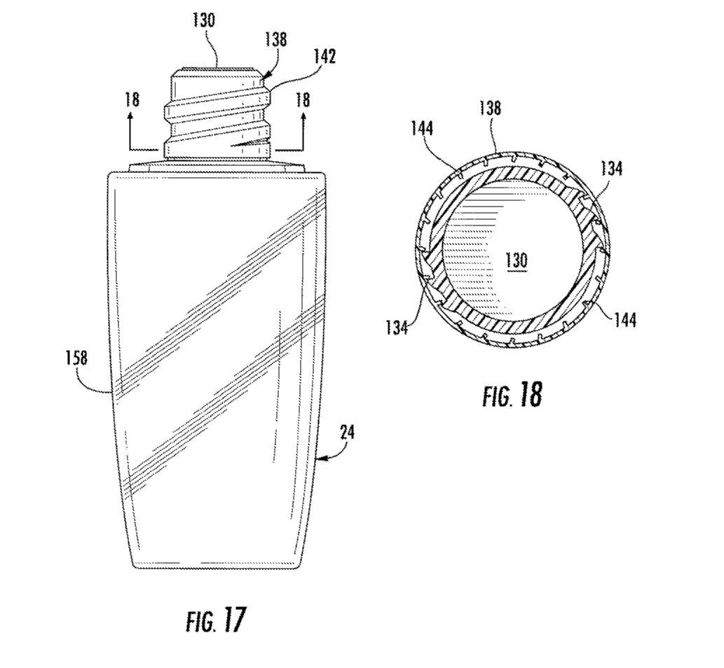

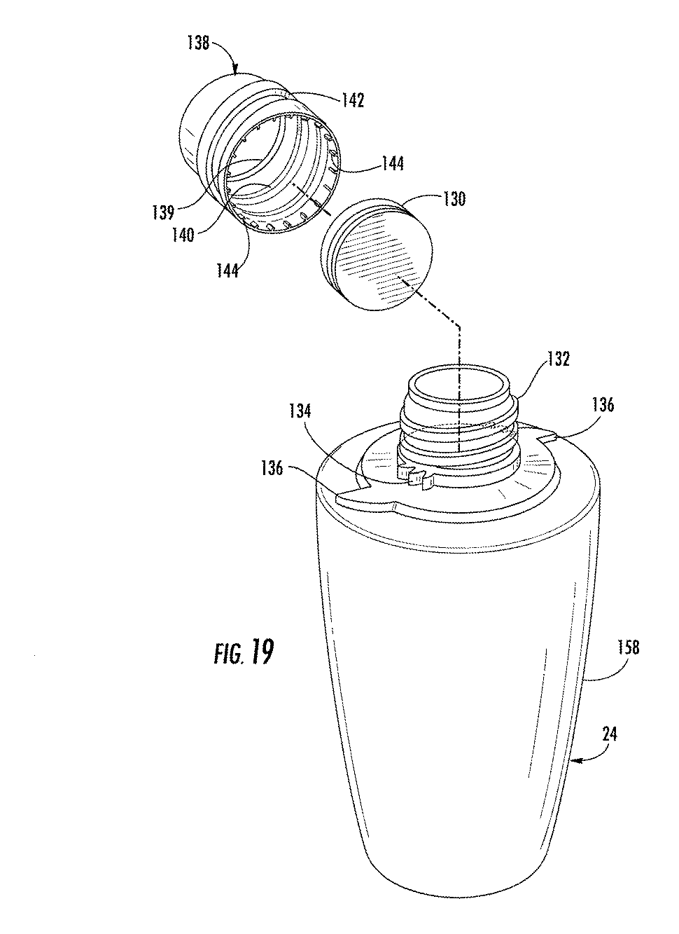

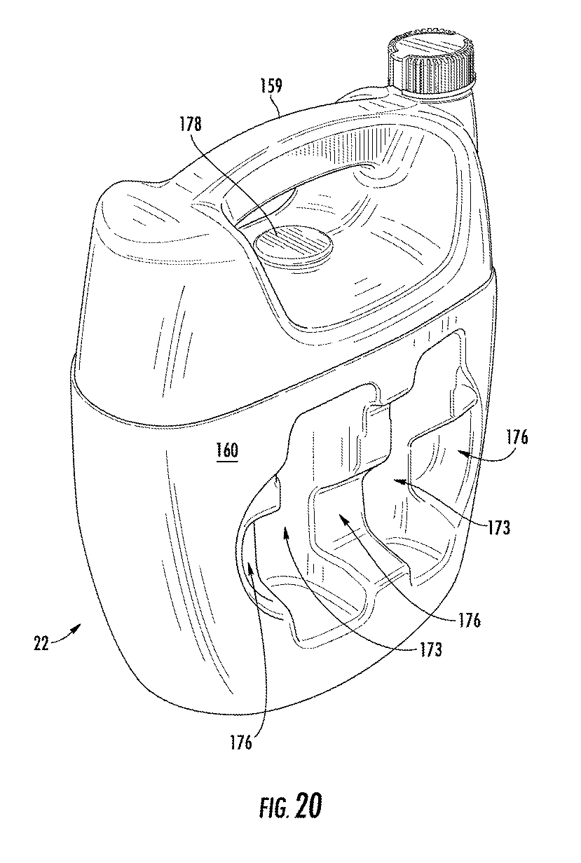

Referring to FIG. 19 and in accordance with the exemplary embodiment, each bottle 24 includes a mouth (e.g., neck), and the mouth includes with one or more helical external threads 132, upper locking projections 134 extending generally radially outwardly from a lower portion of the mouth, and lower locking projections 136 extending generally radially outwardly from the base of the mouth. Referring to FIGS. 16-19, the septum 130 is fixedly held against the end of the mouth of the bottle 24 by a generally cylindrical sleeve 138 having an at least partially open upper end for exposing the septum. As shown in FIG. 13, the upper end of the sleeve 138 may includes an annular, radially inwardly protruding flange 139, wherein at least a portion of the peripheral margin of the septum 130 is pinched between the flange 139 and the upper end of the mouth of the bottle 24. In addition, the annular inner edge of the flange 139 may be received in an outer annular groove of the septum 130 for mounting the septum to the sleeve. The combination of the sleeve 138 and the septum 130 may be characterized as being an inner cap 130, 138, even if the septum is not mounted to the sleeve. The sleeve 138 has one or more helical internal threads 140; one or more helical external threads 142; and inner locking projections 144 extending generally radially inwardly from the lower portion of the sleeve.

Typically after the bottle 24 is initially filled with its dispersible substance such as a treatment concentrate, the mouth of the bottle is closed with the inner cap 130, 138 by way of threaded engagement between the threads 132, 140. That is, the sleeve 138 may be screwed onto the mouth of the bottle 24 such that the septum is secured between the upper end of the mouth of the bottle and the sleeve 138, to close both the mouth of the bottle 24 and the upper end of the sleeve. With the sleeve 138 fully screwed onto the mouth of the bottle 24, the locking projections 134, 144 are engaged to one another in a manner that seeks to prevent (e.g., in a manner that prevents or substantially prevents) the inner cap 130, 138 from being unscrewed from the mouth of the bottle 24. As a result, the inner cap 130, 138 is typically not removed from the mouth of the bottle 24.

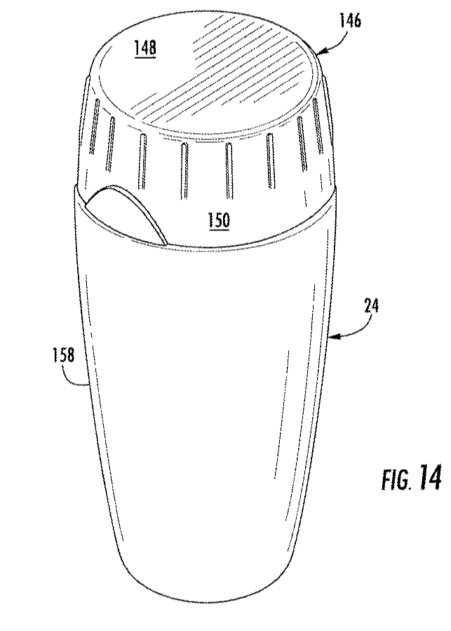

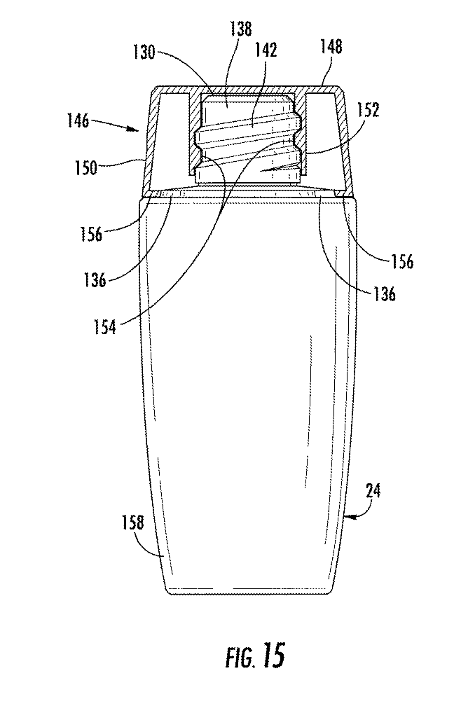

Referring to FIGS. 14 and 15, an outer cap 146 may be releasably secured over the inner cap 130, 138. The outer cap 146 includes a generally circular top wall 148; a generally cylindrical, yet downwardly outwardly tapered sidewall 150; and a generally cylindrical sleeve 152 having one or more helical internal threads 154. The threads 142, 154 are for mating with one another so that the outer cap 146 may be repeatedly screwed onto and off of the inner cap 130, 138. The outer cap 146 includes locking projections 156, and the locking projections 136, 156 engage one another in a manner that seeks to provide a child-resistant safety cap feature that may be overcome by squeezing respective opposite sides of the sidewall 150 inwardly.

In accordance with one example of a method of using the system 20, the user may remove the closure assembly 36 from the tank 22 (e.g., container) and at least partially fill the tank 22 with water (or other suitable liquid dispersion medium) to a desired level. The user may then replace the closure assembly 36 onto the tank, and install the fitting 32 in the receptacle 44 of the closure assembly 36. A bottle 24 (e.g., cartridge) may then be prepared for use by removing its outer cap 146. The mouth of the bottle 24 may then be introduced into the upper opening of the upper receptacle 30, and then be screwed into the upper receptacle by way of threaded engagement between the threads 100, 142, so that the protruding member 114 pierces and extends through the septum 130, and the septum creates a fluid seal around the protruding member. When the tip of the protruding member 114 is blunt, the septum 130 may optionally be prepunctured and/or cut with one or more slits, such as in an x-shaped pattern, to help facilitate penetration of the septum with the protruding member. In the exemplary embodiment, the bottle 24 may be installed to the upper receptacle 30 with a single action, namely by screwing the mouth of the bottle into the upper receptacle. Alternatively, the bottle 24 may be installed to the upper receptacle 30 in any suitable manner.

After installation of the bottle 24 to the upper receptacle 30, when the trigger 39 is activated (e.g., squeezed), liquid from the tank 22 and treatment concentrate from the bottle 24 are drawn into the mixing fitting 54 due to opening of the passageways through the valve tubes 52, 60 and operation of the motorized pump assembly 72, so that the liquid is at least partially mixed with the treatment concentrate in the mixing fitting, or the like. The resulting treatment exits the sprayer 26 by way of the discharge apparatus 29 and exits from (e.g., is sprayed from) the nozzle 120 for use in the particular application.

As mentioned above, the third compound passageway (e.g., the venting passageway) includes the upstream, downstream and intermediate vent tubes 116, 126, 128, the venting passageway 122 and the interior space of the lower receptacle 118. Referring to FIG. 13, when a bottle 24 is installed to the upper receptacle 30, the third compound passageway further includes a passageway defined by clearance between the threads 100, 142, wherein the open end of the vent tube 116 shown in FIG. 11 is in fluid communication with one end of the vent passageway defined by clearance between the threads 100, 142, and the other end of the vent passageway defined by clearance between the threads 100, 142 is open to the ambient environment. The venting passageway 122 extending through the protruding member 114 is for operating in combination with other parts of the third compound passageway for having ambient air flow therethrough into the bottle 24, for venting purposes, in response to operation of the motorized pump assembly 72.

When the application of the treatment is complete, the user may remove the bottle 24 from the upper receptacle 30 and replace the outer cap 146 onto the bottle 24 (where applicable). The user may then turn on the spray system 20 briefly (e.g., by squeezing and then releasing the trigger 39) to flush out the mixing fitting 54 and features downstream therefrom, such as the pump, discharge apparatus 29 and nozzle 120, to prepare the system 20 for later use. If desired, the user may then empty the tank 22. Alternately, the user may leave the remaining liquid in the tank 22 for later use, and/or may begin another treatment. Notably, since the sprayer 26 is typically configured to prevent backflow of the treatment concentrate into the tank 22, such as by way of the passageways through the valve tubes 52, 60 being closed when the trigger is not squeezed, the user can reuse and/or top off the liquid in the tank 22 without concern about the treatment concentrate contaminating the liquid.

When the bottle 24 is empty or nearly empty of its contents, the bottle may be discarded. Thus, the user may have little or no contact with the treatment concentrate at any time during the treatment process. Any suitable treatment may be contained in and supplied by the bottles 24 (e.g., cartridges). Examples of treatments that may be suitable include, hut are not limited to, pesticides, herbicides, fungicides, fertilizers, soil conditioners, pH adjusters, aerating treatments (e.g., microbe-based treatments), surfactants, or any suitable combination thereof. Such treatments may find use in residential or commercial lawn, plant, or garden care, animal care, or home or building care (e.g., cleansers, biocides, mildew treatments, and so on).

As shown in FIGS. 14-17 for the exemplary embodiment, the sidewall 158 of the bottle 24 tapers along the length of the vertical axis of the bottle, so that the diameter of the bottle continually increases in the direction from the base of the bottle toward the shoulder at the base of the mouth of the bottle. The bottles 24 of the exemplary embodiment are typically blow molded from rigid polymeric (e.g., plastic) material, although they may alternatively be formed of any other suitable material in any other suitable manner, and the bottles may not be tapered or may be tapered differently.

Referring to FIGS. 2, 4 and 20-22, the tank 22 (e.g., container) of the exemplary embodiment is typically blow molded from rigid polymeric (e.g., plastic) material to include a bottom wall, at least one side wall extending upwardly from the bottom wall and around an interior of the tank, an upper wall, and a handle 159 extending over the upper wall. Whereas the tank 22 may include a generally cylindrical sidewall, the tank of the exemplary embodiment is generally block shaped, such that the at least one upright side wall comprises opposite major walls and opposite minor walls, and one of the major walls includes/defines one or more side-loading holders that are each adapted for holding a construct, wherein the construct may be one of the bottles 24 (e.g., cartridges).

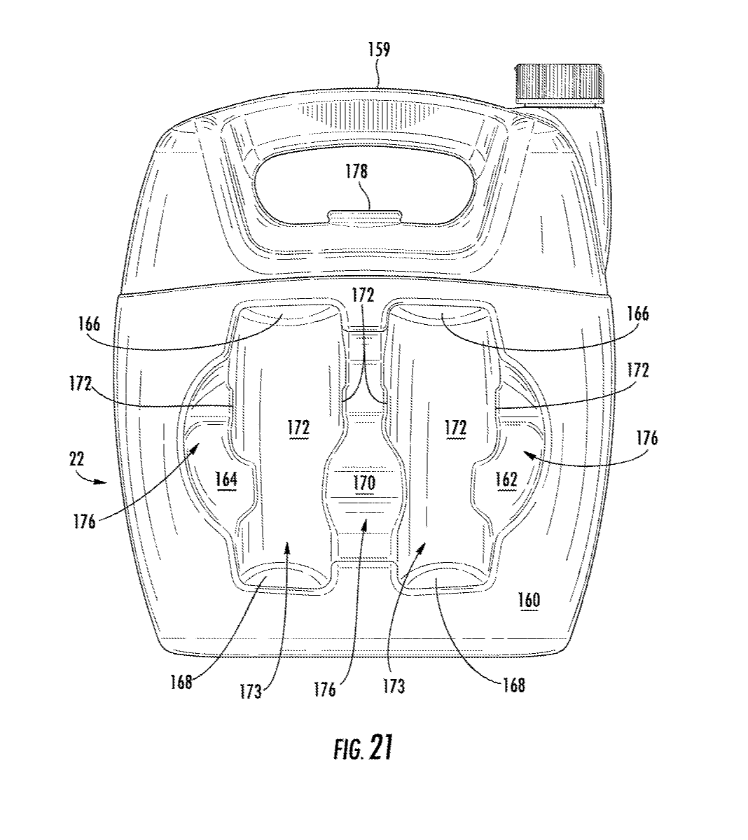

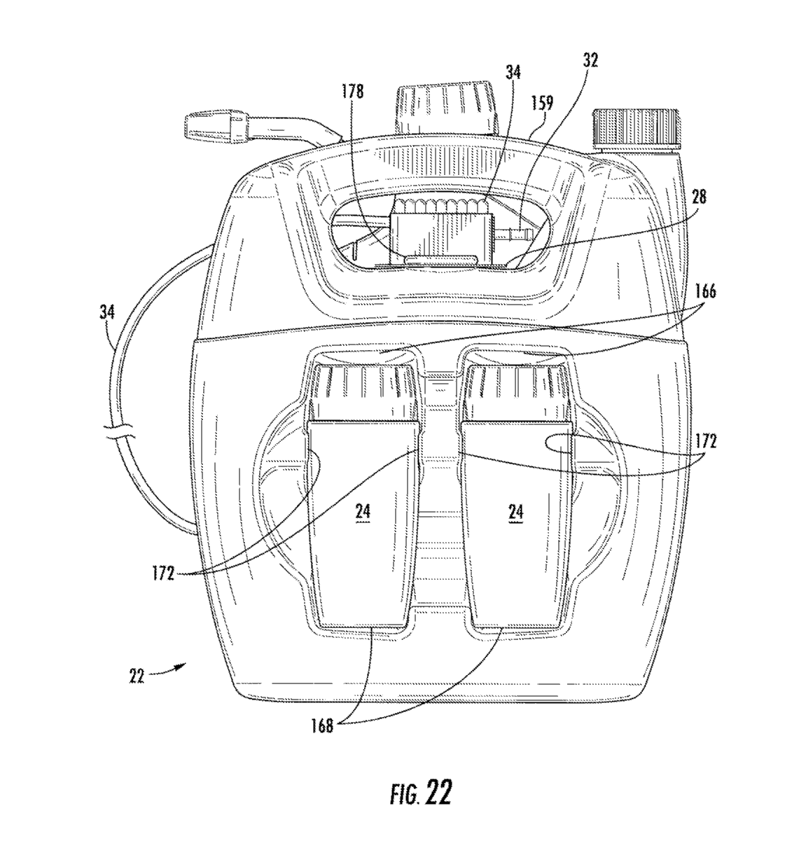

Referring to FIGS. 20 and 21, the features that form the side-loading holders are integrally formed in the respective major wall of the tank 22 (e.g., container), and that major wall includes a marginal wall portion 160 that circumscribes the holders, and a plurality of wall portions that define the cavities of the holders. The plurality of wall portions of the subject major wall of the tank 22 include the following contoured wall portions that extend inwardly from respective edges of the marginal wall portion 160: right and left wall portions 162, 164; right and left top wall portions 166; right and left bottom wall portions 168; and a central wall portion 170. For each side-loading holder, the top and bottom wall portions 166, 168 each extend obliquely with regard to horizontal, so that the top and bottom wall portions 166, 168 extend divergently with respect to one another in the outward direction. The plurality of wall portions further includes right and left conformed wall portions 172. Each of the conformed wall portions 172 substantially conforms in shape, and is for substantially engaging, about half of one of the capped bottles 24, wherein the subject half includes the entire length of the capped bottle.

The right conformed wall portion 172 extends between the inner edges of the right top and bottom wall portions 166, 168, and inwardly from inner edges of the right and central wall portions 162, 170, so that these wall portions define a main cavity 173 for removably receiving the respective bottle 24. The left conformed wall portion 172 extends between the inner edges of the left top and bottom wall portions 166, 168, and inwardly from inner edges of the left and central wall portions 164, 170, so that these wall portions define a main cavity 173 for receiving the respective bottle 24. Each main cavity 173 is at least partially upwardly and downwardly closed by its top and bottom wall portions 166, 168. Each of the conformed wall portions 172 is, with respect to the vertical axis of the bottle 24 positioned thereagainst, an axially extending concave wall portion extending between the respective top and bottom wall portions 166, 168.

For each aid holder that is fully in receipt of its bottle 24 (e.g., cartridge), the conformed wall portion 172 extends partially around the vertical axis of the bottle. More specifically, a part of the conformed wall portion 172 extends less than or equal to one hundred and eighty degrees around the vertical axis of the bottle fully received by the conformed wall portion. In contrast, a part of the conformed wall portion 172 extends more than one hundred and eighty degrees around the vertical axis of the bottle 24 fully received by the contoured wall, wherein at least one end of the part of the conformed wall portion that extends more than one hundred and eighty degrees around the vertical axis at least partially forms at least one projection for engaging a portion of the bottle 24 for restricting the bottle from being removed from the main cavity 173 of the holder. The at least one projection may be in the form of opposite lobes 174 that extend toward one another to define a gap therebetween for having at least a portion of the bottle 24 pass therethrough, wherein the gap is narrower than at least a portion of the bottle 24 for restricting the bottle from being removed from the main cavity 173. More specifically, the opposite lobes 174 may comprise the opposite end portions of the part of the conformed wall portion 172 that extends more than one hundred and eighty degrees around the vertical axis. Each lobe 174 may also be characterized as including an associated part of the respective right, left and central wall portions 162, 164, 170.

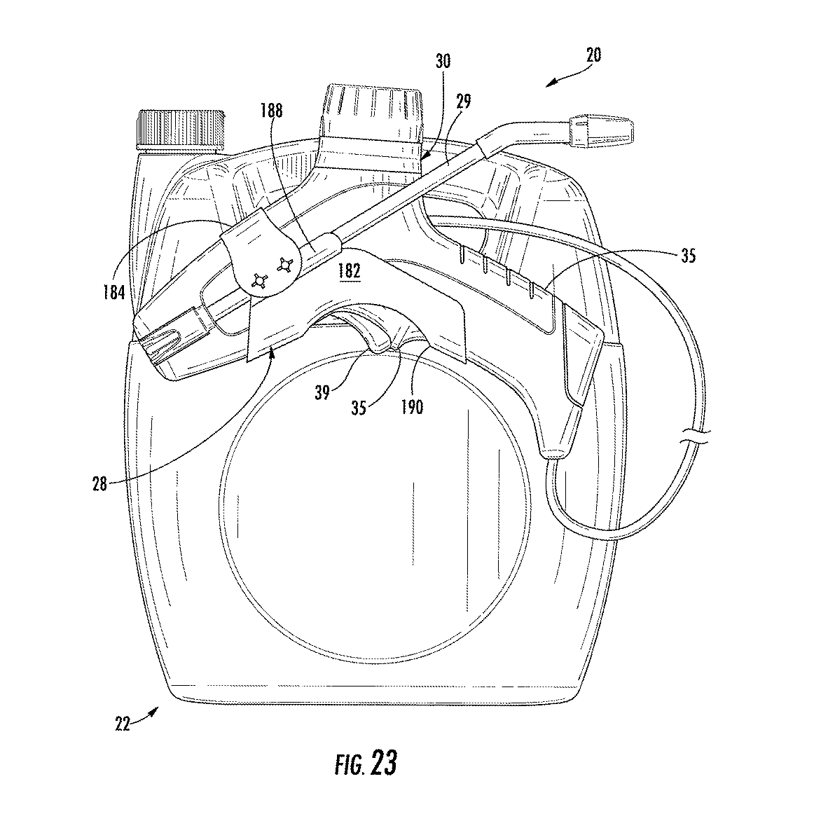

Referring to FIG. 22, each pair of opposite lobes 174, optionally together with the remainder of the associated part of the conformed wall portion 172 that extends more than one hundred and eighty degrees around the vertical axis, may be characterized as being a generally c-shaped, rigid retaining bracket for holding the sidewall 158 of one of the bottles 24. For example, in the rigid retaining bracket, the size of the gap defined between adjacent lobes 174 may not vary, or substantially does not vary, while the bottle 24 is being installed to or removed from the main cavity 173 of the bottle holder. In this regard and in the exemplary embodiment in which both the tank 22 and the bottle 24 are made of rigid polymeric (e.g., plastic) material, the distance between the top and bottom wall portions 166, 168 is greater than the height of the capped bottle, so that a lower portion of an upright bottle's downwardly inwardly tapered sidewall 158 can be passed inwardly through the gap between the lobes 174 and into the main cavity 173, and then the bottle 24 may be lowered so that the diameter of the portion of the sidewall 158 adjacent the gap between the lobes is too large to pass through the gap between the lobes. Thereafter, the bottle 24 may be removed from the main cavity 173 by lifting the bottle within the main cavity, and then pulling the bottle forward so that the lower portion of the upright bottle's downwardly inwardly tapered sidewall 158 passes outwardly through the gap between the lobes 174.

Alternatively or additionally, the tank 22 and/or and the bottle 24 may be constructed of a more resilient, flexible polymeric (e.g., plastic) material. In one example, the sidewall 158 of the bottles 24 deforms to pass through gap defined between adjacent lobes 174. In another example, each pair of opposite lobes 174, optionally together with the remainder of the associated part of the conformed wall portion 172 that extends more than one hundred and eighty degrees around the vertical axis, may be a generally c-shaped, flexible clip for holding (e.g., gripping) the sidewall of one of the bottles 24 (e.g., cartridge), so that the gap defined between adjacent lobes 174 widens as the bottle 24 is forced therethrough, and the gap between the adjacent lobes 174 thereafter narrows, such as to releasably hold the bottle in the main cavity 173.

For facilitating installation of a bottle 24 to, and removal of the bottle from, its main cavity 173, each of the right, left and central wall portions 170 may define a cavity 176 (FIGS. 20 and 21) adjacent the main cavity for receiving the fingers of a user, so that the user may hold the opposite sides of the bottle with his or her fingers during the installation or removal of the bottle from its main cavity. Alternatively, or additionally, at least one projection of the tank 22 may be configured differently, for cooperatively interacting with at least one corresponding detent in the bottle 24 for releasably restricting the bottle from being removed from the main cavity 173 of the bottle holder and/or at least one projection of the bottle may be configured for cooperatively interacting with at least one corresponding detent in the tank for releasably restricting the bottle from being removed from the main cavity 173 of the bottle holder.

Referring to FIGS. 1-4 and 20-22, a mounting lug 178 is integrally formed in the upper wall of the tank 22 so that the handle 159 of the tank is spaced apart from and extends over (e.g., substantially directly over) the lug. The lug 178 includes an upper annular head and a lower annular groove, so that the lug is configured for supporting/carrying a construct and/or having the construct mounted thereto, wherein the construct may be the holster 28. In this regard and referring to FIGS. 1-3, 22 and 23, the holster 28 includes an end section having a mounting hole 180 extending therethrough. The lug 178 extends through the holster's mounting hole 180, and a series of tabs of the holster 28 extend inwardly into both the hole and the annular groove of the lug for releasably securing the holster to the lug.

As best understood with reference to FIGS. 3 and 23, the holster 28 includes a cradle 182, and a strap 184 extends over a front section of the cradle. The strap 184 has opposite ends that are respectively connected to opposite sides of the front section of the cradle. One end of the strap 184 may be releasably connected to one of the sides of the front section of the cradle 182 by snaps, snap-like features 186, or any other suitable fastening mechanism(s). Typically both ends of the strap 184 remain connected to the cradle 182 so that the strap and the front section of the cradle form a passageway that is confirmed in shape to the front end of the sprayer 26, for receiving the front end of the sprayer. In this regard, the front section of the cradle 182 further includes a trough 188 for receiving a portion the discharge apparatus 29 in its unextended configuration. The cradle 182 includes an intermediate hole 190 therethrough that is positioned between the front and rear sections of the cradle 182. The cradle's hole 190 is for receiving the trigger 39 and associated portions of the grip 35. The rear section of the cradle 182 is confirmed in shape to a respective portion of the grip 35, for receiving the respective portion of the grip. The front and rear sections of the cradle 182 both extend obliquely from horizontal and downwardly from the intermediate hole 190 hole for securely receiving the sprayer's front and rear portions, respectively, so that the upper receptacle 30 is an upright configuration.

Referring to FIGS. 1 and 3, the holster 28 may include an upwardly open trough 183 positioned between the mounting hole 180 and the cradle 182. The trough 183 may removably receive the supply tube 34 in a coiled configuration. A wall of the trough 183 may include a concavity for receiving the body 45 of the fitting 32 so that the wall is releasably held between flanges of the body of the fitting. Alternatively, the mounting lug 178, handle 159, and/or holster 28 may be omitted or configured differently.

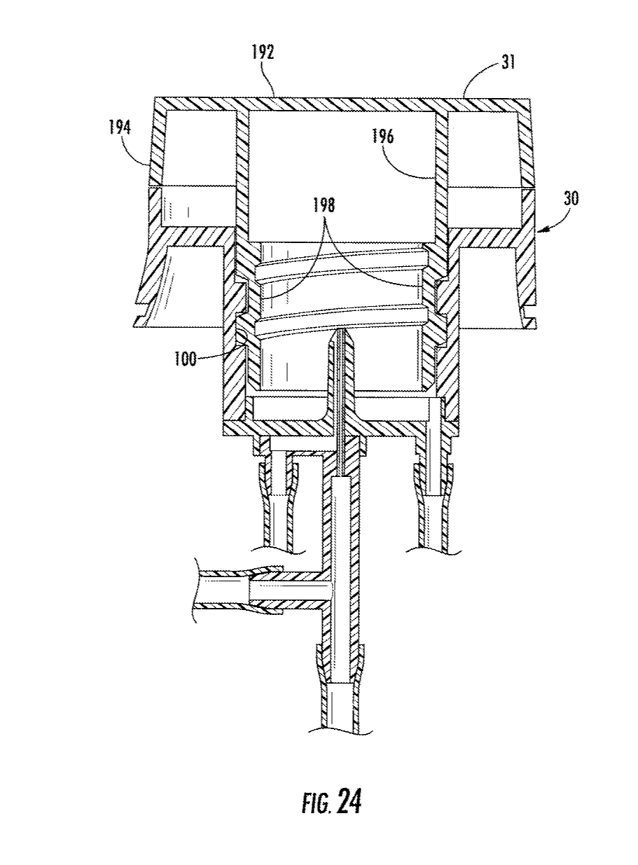

Referring primarily to FIG. 24, the cap 31 may be releasably secured to the upper receptacle 30. The cap 31 includes a generally circular top wail 192; a generally cylindrical, yet downwardly outwardly tapered sidewall 194; and a generally cylindrical sleeve 196 having one or more helical external threads 198. The threads 100, 198 are for mating with one another so that the cap 31 may be repeatedly screwed onto and off of upper receptacle 30. The cap 31 may be omitted or configured differently, such as by being in the form of a plug or other suitable structure.

While the present inventions are described herein in detail in relation to specific aspects and embodiments, it is to be understood that this detailed description is only illustrative and exemplary of the present inventions and is made merely for purposes of providing a full and enabling disclosure of the present inventions and to set forth the best mode of practicing the inventions as known to the inventors. The detailed description set forth herein is illustrative only and is not intended, nor is to be construed, to limit the present inventions or otherwise to exclude any such other embodiments, adaptations, variations, modifications, and equivalent arrangements of the present inventions. All directional references (e.g., upper, lower, upward, downward, left, right, top, bottom, above, below, vertical and horizontal) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, mounted and the like) are to be construed broadly and may include intermediate members between a connection of elements and relative movement between elements. As such, joinder references do not necessarily imply that two elements are connected directly and in fixed relation to each other. Regarding any dimensions provided by this disclosure, they may be as indicated and/or they may be approximate, and any other suitable dimensions may be used.

Further, various elements discussed with reference to the various embodiments may be interchanged to create entirely new embodiments coming within the scope of the present invention. For example, each of the embodiments may be like one or more of the other embodiments, except for variations noted and variations that will be apparent to those of ordinary skill in the art. For example, the features of the various embodiments may be used in a wide variety of combinations and subcombinations, such that an embodiment may include a combination of features from different embodiments.

The above examples are in no way intended to limit the scope of the present invention. It will be understood by those skilled in the art that while the present disclosure has been discussed above with reference to exemplary embodiments, various additions, modifications and changes can be made thereto without departing from the spirit and scope of the invention as set forth in the claims.

What is claimed is:

1. A sprayer system for forming and spraying a dispersion comprising water and a dispersible substance, the sprayer system comprising:
a tank for containing the water;
a cartridge for containing the dispersible substance;
a sprayer for being in fluid communication with the tank and the cartridge, the sprayer comprising
a housing comprising a receptacle for removably receiving the cartridge,
a first passageway carried by the housing,
a pump mounted to the housing and in fluid communication with the first passageway for drawing the water from the tank into the first passageway while the sprayer is in fluid communication with the tank,
a second passageway carried by the housing and in fluid communication with both the receptacle and the first passageway for supplying the dispersible substance from the cartridge to the first passageway and, thereby, forming the dispersion in response to operation of the pump while the receptacle is in receipt of the cartridge and the sprayer is in fluid communication with the tank, and
a discharge apparatus for dispensing the dispersion from the sprayer in response to operation of the pump while the receptacle is in receipt of the cartridge and the sprayer is in fluid communication with the tank.

2. The sprayer system according to claim 1, wherein:
the receptacle comprises at least one helical internal thread; and
the cartridge comprises at least one helical external thread for cooperative threaded engagement with the internal thread of the receptacle.

3. The sprayer system according to claim 1, comprising at least a portion of a cap that is threadedly engaged in the receptacle.

4. The sprayer system according to claim 1, further comprising:
an electric motor connected to the pump for driving the pump, wherein the housing comprises a battery compartment for containing at least one battery for providing electrical power to the motor; and
an electrical switch controlled by a manually operable mechanism for controlling the supply of electrical power to the motor.

5. The sprayer system according to claim 4, wherein the manually operable mechanism is a trigger pivotably mounted to the housing of the sprayer.

6. The sprayer system according to claim 1, further comprising both a cavity and a bracket that are integrally formed with the tank, wherein the bracket is for releasably holding the cartridge in the cavity.

7. The sprayer system according to claim 6, wherein the bracket is a clip.

8. The sprayer system according to claim 6, wherein the cartridge is a first cartridge, and further comprising a second cartridge, and wherein the receptacle is in receipt of the second cartridge.

9. A sprayer for spraying a dispersible substance from a cartridge and a liquid dispersion medium from a source, the sprayer comprising:
a housing comprising a receptacle for removably receiving the cartridge;
a first passageway carried by the housing;
a pump mounted to the housing and in fluid communication with the first passageway for drawing the liquid dispersion medium into the first passageway while the sprayer is in fluid communication with the source;
a second passageway carried by the housing and in fluid communication with both the receptacle and the first passageway for supplying the dispersible substance from the cartridge to the first passageway and in response to operation of the pump while the receptacle is in receipt of the cartridge and the sprayer is in fluid communication with the source, and
a discharge apparatus for dispensing the dispersible substance and the liquid dispersion medium from the sprayer in response to operation of the pump while the receptacle is in receipt of the cartridge and the sprayer is in fluid communication with the source.

10. The sprayer according to claim 9, wherein a connection between the first and second passageways is positioned upstream from the pump.

11. The sprayer according to claim 9, wherein discharge apparatus is pivotably mounted to the housing for being pivoted between extended and unextended configurations.

12. The sprayer according to claim 9, comprising a fitting comprising first and second inlets and an outlet configured so that each of the first and second inlets is in fluid communication with the outlet, wherein:
the first passageway is a compound passageway comprising the first inlet and the outlet; and
the second passageway is a compound passageway comprising the second inlet.

13. The sprayer according to claim 9, comprising at least a portion of a cap that is threadedly engaged in the receptacle.

14. The sprayer according to claim 9, further comprising at least one valve positioned in a passageway selected from the group comprising the first passageway and the second passageway, and an actuator mechanism for opening and closing the at least one valve, the actuator mechanism being configured so that the at least one valve is:
open while the pump is operating, and
closed while the pump is not operating.

15. The sprayer according to claim 14, further comprising an electric motor connected to the pump for driving the pump, a battery compartment for containing at least one battery for providing electrical power to the motor, a trigger pivotably carried by a hinge pin, at least one trigger spring, and an electrical switch controlled by the trigger for controlling the supply of electrical power to the motor, wherein:
the trigger comprises opposite first and second arms,
the at least one valve comprises
a first valve actuated by the first arm of the trigger, and
a second valve actuated by the second arm of the trigger.

16. The sprayer according to claim 9, wherein:
the receptacle comprises an interior space and an opening, wherein the interior space is for receiving at least a portion of the cartridge by way of the opening;
a protruding member extends into the interior space of the receptacle for extending into an interior of the cartridge while the receptacle is in receipt of the cartridge; and
the second passageway comprises a passageway extending through the protruding member.

17. The sprayer according to claim 16, further comprising a third passageway carried by the housing, wherein the third passageway comprises a passageway extending through the protruding member.

18. The sprayer according to claim 9, further comprising:
an electric motor connected to the pump for driving the pump, wherein the housing comprises a battery compartment for containing at least one battery for providing electrical power to the motor; and
an electrical switch controlled by a manually operable mechanism for controlling the supply of electrical power to the motor.

19. The sprayer according to claim 18, wherein the manually operable mechanism is a trigger pivotably mounted to the housing of the sprayer.

20. The sprayer according to claim 9, further comprising at least one valve positioned in a passageway selected from the group consisting of the first passageway and the second passageway, and an actuator mechanism for opening and closing the at least one valve, the actuator mechanism being configured so that the at least one valve is:
open while the pump is operating, and
closed while the pump is not operating.

21. The sprayer according to claim 20, further comprising an electric motor connected to the pump for driving the pump, a battery compartment for containing at least one battery for providing electrical power to the motor, a trigger pivotably carried by a hinge pin, at least one trigger spring, and an electrical switch controlled by the trigger for controlling the supply of electrical power to the motor, wherein:
the trigger comprises opposite first and second arms,
the at least one valve comprises
a first valve actuated by the first arm of the trigger, and
a second valve actuated by the second arm of the trigger.

22. A sprayer for combining and spraying a liquid dispersion medium from a source and a dispersible substance from a cartridge, the sprayer comprising:
a housing comprising a receptacle for removably receiving the cartridge, the receptacle comprising an interior space and an opening, wherein the interior space is for receiving at least a portion of the cartridge by way of the opening;
a protruding member extending into the interior space of the receptacle for extending into an interior of the cartridge while the receptacle is in receipt of the cartridge, the protruding member defining a passageway extending through the protruding member;
a supply tube mounted to the housing;
a pump mounted to the housing and in fluid communication with both the passageway extending through the protruding member and the supply tube for
drawing the liquid dispersion medium through the supply tube in response to operation of the pump while the supply tube is in fluid communication with the source, and
drawing the dispersible substance through the passageway of the protruding member in response to operation of the pump while the receptacle is in receipt of the cartridge; and
a discharge apparatus for dispensing the dispersible substance and the liquid dispersion medium from the sprayer in response to operation of the pump while the receptacle is in receipt of the cartridge and the supply tube is in fluid communication with the source.

23. The sprayer according to claim 22, wherein:
the passageway of the protruding member is a first passageway; and
the protruding member further defines a second passageway extending through the protruding member, and the second passageway is in fluid communication with the ambient environment for venting the interior of the cartridge while the receptacle is in receipt of the cartridge.

24. A cartridge for supplying a substance to a sprayer, the cartridge comprising:
a bottle having a mouth defining an opening to an interior of the bottle, and the mouth having at least one external thread;
a cap closing the opening to the mouth, the cap comprising
a sleeve with at least one internal thread engaged with the external thread of the mouth, and
a septum at least partially closing both the opening to the mouth and an end of the sleeve.

25. The cartridge according to claim 24, wherein the sleeve has at least one external thread, the cap is an inner cap, and further comprising an outer cap, the outer cap at least partially covering the inner cap, the outer cap having at least one internal thread engaged with the external thread of the sleeve.

26. A container for internally containing a liquid and externally carrying at least one construct, the container comprising:
a top wall, a bottom wall and at least one sidewall extending around an interior of the container, the interior being adapted for containing the liquid; and
at least one feature selected from the group consisting of a side-loading holder defined by the at least one sidewall, wherein the holder is adapted for holding the construct, and
a mounting lug integrally formed in the top wall, wherein the mounting lug is adapted for having the construct mounted thereto.

27. The container according to claim 26, wherein:
the construct is a bottle;
the at least one sidewall comprises a sidewall defining both a cavity of the holder and a side opening to the cavity;
the cavity is for removably receiving the bottle by way of the side opening of the cavity; and
the sidewall comprises at least one protection for engaging a portion of the bottle for restricting the bottle from being removed from the cavity.

28. The container according to claim 27, wherein the at least one projection comprises opposite lobes that extend toward one another to define a gap for having at least a portion of the bottle pass therethrough, wherein the gap is narrower than at least a portion of the bottle for restricting the bottle from being removed from the cavity.

29. The container according to claim 27, wherein the cavity is at least partially upwardly closed and the cavity is at least partially downwardly closed.

30. The container according to claim 26, in combination with the construct, wherein the construct is a holster having a hole through which the mounting lug extends.
